(19) United States
(12) Patent Application Publication
(10) Pub. No.: US 2022/0329671 A1
(43) Pub. Date: Oct. 13, 2022

(54) SYSTEMS AND METHODS FOR CROSS DOMAIN SOLUTIONS IN MULTI-CLOUD ENVIRONMENTS

(71) Applicant: ManTech International Corporation, Herndon, VA (US)

(72) Inventors: Sandeep SHILAWAT, Herndon, VA (US); Neema SHABESTARI, Reston, VA (US)

(73) Assignee: ManTech International Corporation, Herndon, VA (US)

(21) Appl. No.: 17/658,175

(22) Filed: Apr. 6, 2022

Related U.S. Application Data
(60) Provisional application No. 63/172,373, filed on Apr. 8, 2021.

(51) Int. Cl. H04L 67/564

(52) U.S. Cl. CPC H04L 67/564

(57) ABSTRACT

Methods and systems for cross domain solution for communication of secure data are disclosed and include receiving, at a first trust manager of a data proxy, first data from a first proxy server, wherein the first data includes a destination location for a second server; verifying, by the first trust manager, a registration of the first proxy server, wherein the verifying includes confirming a first credential; verifying, by a second trust manager of the data proxy, a registration of the second proxy server, wherein the verifying including confirming a second credential; performing a redaction procedure for the first data based on verifying the first proxy server and the second proxy server, to output redacted data based on the first data; and providing the redacted data to the second proxy server based on the registration of the second proxy server and the destination location.

### CROSS-REFERENCE TO RELATED APPLICATIONS

This application claims priority to U.S. Provisional Application No. 63/172,373 filed Apr. 8, 2021, the entire disclosure of which is hereby incorporated herein by reference in its entirety.

### TECHNICAL FIELD

Various embodiments of the present disclosure relate generally to data access security brokers, and more particularly, to systems and methods for providing a cross domain solution for communication of secure data.

### BACKGROUND

Entities operating in a cloud based atmosphere often exchange data using a cloud architecture. Although exchange of such data in an unsecured environment may occur via network communication between two or more components, exchange of data from a secured environment or secured data itself may not be transmitted via traditional network communications between components (e.g., due to security concerns). For example, secure agencies utilize on premise secure networks to exchange data between components. These secure networks are closed off to external networks and the public to prevent security breaches. However, operating within such security networks limits operations and reduced overall efficiency.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for providing a cross domain solution for communication of secure data.

In one aspect, providing a cross domain solution for communication of secure data using a plurality of machine learning models includes receiving, at a first trust manager of a data proxy, first data from a first proxy server, wherein the first data comprises a destination location for a second proxy server; verifying, by the first trust manager, a registration of the first proxy server, wherein the verifying comprises confirming a credential; receiving second server attributes of the second proxy server and providing the second proxy server attributes as inputs to a trust machine learning model; verifying the second proxy server based on a trust value output by the trust machine learning model; receiving the first data based on verifying the first proxy server, identification information of the first proxy server, and identification information of the second proxy server as an input to a rule machine learning model; receiving a rule engine as an output of the rule machine learning model; applying the rule engine to the first data; performing a redaction procedure for the first data based on applying the rule engine to the first data, to output redacted data; and providing the redacted data to the second proxy server based on the destination location and the verifying the second proxy server.

According to another aspect, providing a cross domain solution for communication of secure data using a plurality of machine learning models includes receiving, at a first trust manager of a data proxy, first data from a first proxy server, wherein the first data comprises a destination location for a second server; verifying, by the first trust manager, a registration of the first proxy server, wherein the verifying comprises confirming a first credential; verifying, by a second trust manager of the data proxy, a registration of the second proxy server, wherein the verifying comprises confirming a second credential; performing a redaction procedure for the first data based on verifying the first proxy server and the second proxy server, to output redacted data based on the first data; and providing the redacted data to the second proxy server based on the registration of the second proxy server and the destination location.

According to another aspect, a system for providing a cross domain solution for communication of secure data includes at least one memory storing instructions and at least one processor executing the instructions to perform a process, the processor configured to: receive, at a first trust manager of a data proxy, first data from a first proxy server, wherein the first data comprises a destination location for a second server; verify, by the first trust manager, a registration of the first proxy server, wherein the verifying the registration of the first proxy server comprises confirming a first credential; verify, by a second trust manager of the data proxy, a registration of the second proxy server, wherein the verifying the registration of the second proxy server comprises confirming a second credential; perform a redaction procedure for the first data based on verifying the first proxy server and the second proxy server, to output redacted data based on the first data; and provide the redacted data to the second proxy server based on the registration of the second proxy server and the destination location.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment of a cross domain solution for communication of secure data, according to one or more embodiments.

FIG. 2 depicts a data flow diagram for providing a cross domain communication of secure data, according to one or more embodiments.

FIG. 3 depicts a flowchart of an exemplary method of providing a cross domain communication of secure data, according to one or more embodiments.

FIG. 4 depicts an example training module to train one or more of the machine learning models, according to one or more embodiments.

FIG. 5 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, article, or apparatus that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

As used herein, an “install” or an “installation” of a program may be the downloading or obtaining of a program and making the program ready for execution on an electronic component (e.g., a cloud instance, a computer, etc.). An installation may refer to a particular configuration of a software, firmware, and/or hardware making it usable with at least one electronic component. The installation may be initiated by a user for a given component or may be conducted at an entity or department level such that the installation occurs for multiple users and/or multiple components.

As used herein, a “data proxy” may be implemented using one or more processors, servers, memory, or the like that allow enterprise operations and communications across security domain boundaries. The data proxy may function as a cross domain proxy “sandwich” that facilitates outbound communication sourced from a classified or secured network. A data proxy may function as a sandwich such that outbound communications may traverse in one direction from a secure (e.g., classified or restrained) network, may be received and analyzed by a data proxy trap, and may then be output to a different (e.g., unsecured) network.

As used herein, a “rule engine” may be implemented using one or more processors, servers, memory, or the like and may be used to execute one or more rules that are related to a user, an entity, a security level, or the like. The rule engine may be part of the data proxy or may be an independent process. The rule engine may be a pre-determined or dynamically determined rule engine. Rules applied by the rule engine may be applied for each instance or for each user of a given entity. For example, if a given agency uses a data proxy for the entire agency, then the rule engine may apply the same rules when any user from the agency transmits data via the data proxy. The rule engine may be dynamic such that the rules applied by the rule engine may vary based on one or more factors such as the user, user security credentials, department, or the like. As an example, a user may transmit data via a data proxy that authenticates the user and determines a user based rule set applied using the data proxy's rule engine. The user based rule set may be different than another rule set used for another user.

According to an implementation, a rule machine learning model may output one or more rules to be applied for a user or entity. The rule machine learning model may be trained (e.g., supervised, unsupervised, semi-supervised, etc.) using training data that provides historical rule outputs based on entity, data, or user information. One or more weights, layers, and/or biases of the rule machine learning model may be adjusted based on such training data. Alternatively, or in addition, the rule machine learning model may be trained by receiving entity, data, or user information, and clustering the information to adjust one or more weights, layers, and/or biases of the rule machine learning model. Once trained, the rule machine learning model may receive, as inputs, secure network data, user data, entity data, secure source information, and/or unsecure destination information. The rule machine learning model may apply the inputs to one or more weights, layers, and/or biases of the rule machine learning model and may output a rule or a set of rules based on the inputs.

As used herein, a “trust manager” may be implemented using one or more processors, servers, memory, or the like, and may verify that data is either received at a data proxy from a trusted source or may verify that data is being provided to a trusted source. A given data proxy may utilize multiple trust managers such as two trust mangers on each end of a guard. For example, a data proxy may include a first trust manager to authenticate incoming data from a secured network and a second trust manager to authenticate an open network to receive the data. Each trust manager of a data proxy may operate independently from each other trust manager. A trust manager may authenticate an entity, user, or component providing the data based on credentials, certificates, and/or the like.

As used herein, a “cloud vendor” may be a cloud service provider that enables an entity to create, host, launch, or otherwise activate one or more cloud accounts and provides cloud resources to use the one or more cloud accounts. Examples of cloud vendors include, but are not limited to, Amazon Web Services® (AWS®), Google Cloud®, Microsoft Azure®, and the like. A cloud vendor may provide cloud services in addition to activating cloud accounts. The cloud services may allow an entity to manage user accounts within the cloud vendor's ecosystem. An entity using multiple cloud vendors may manage cloud accounts associated with a first cloud vendor via the first cloud vendor's management platform and may manage cloud accounts associated with a second cloud vendor via the second cloud vendor's management platform.

As used herein, a “software vendor” may be a vendor that integrates with a cloud vendor and provides a service to, or based on, the cloud vendor. Example software vendors may provide provisioning of auto-generated accounts (e.g., creating cloud accounts via a cloud vendor on an as needed basis), conducting compliance checks, implementing financial controls, managing digital workflows for enterprise operation, cloud management, cloud implementation, and/or the like. Software vendors may provide services to individual cloud vendors.

Entities such as secure agencies that are looking to deploy their classified cloud workloads often have secure on premise networks and deployed edge networks they operate and maintain. Such entities often find it difficult to maintain security protocols while providing access to all portions of an enterprise which may include on or more of multiple closed networks, classified networks, compute/storage enclaves, or the like operating in commercial cloud regions. Cloud vendor solutions including hybrid clouds do not deliver a holistic service desk or a view of network resources across security classification boundaries. Techniques disclosed herein, at least in part, provide a solution to address the need to share data housed in different security classification domains while mitigating threats for data spillage or leaks. Accordingly, techniques disclosed herein facilitate cross domain traffic communication in a secure manner.

Data stored within a secure enterprise information system (e.g., a secure source, as used herein) may be managed in isolated networks with separate solutions because existing accredited capabilities may not allow seamless information sharing between security classification domains. For example, one information system may not be capable of sharing data with another (e.g., if data is classified), without a trusted solution that mitigates the risk of data spillage, as disclosed herein.

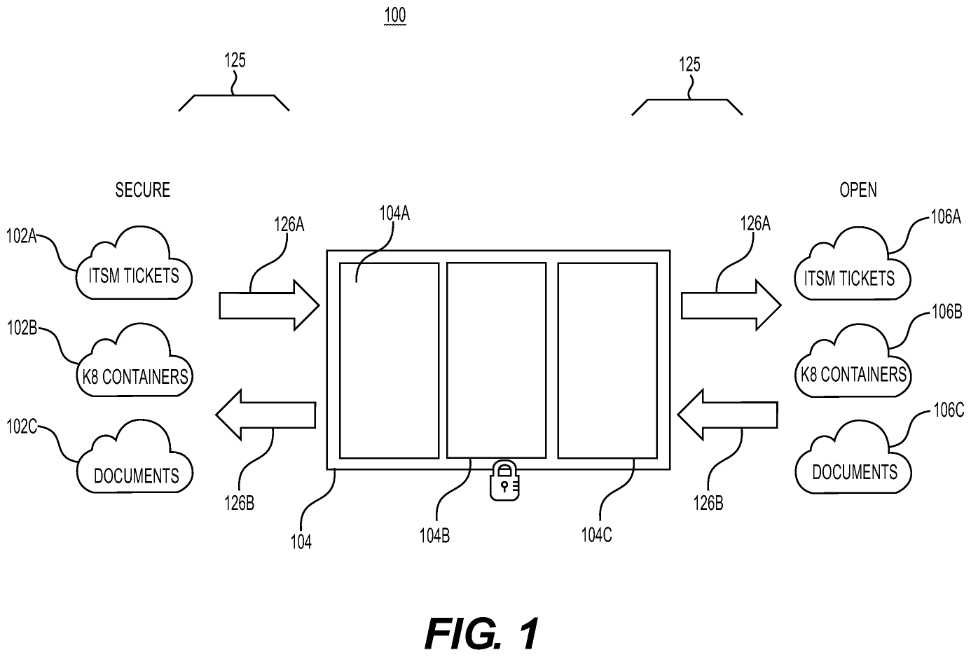

Techniques disclosed herein provide classification marking products to develop a consolidated set of rules to transfer data between secure (e.g., classified or restrained) networks and open networks with mitigated risk of data spillage. As disclosed herein, a low-side network (i.e., a less secure than a high-side network) may be configured with a proxy software to handle data transfer to/from a high-side network (i.e., a more secure than a low side network). The high-side network may be configured with a proxy software to handle data transfer to/from the low-side network. One or more rule engines may be used to manage the data transferred between the high-side and the low-side. The rule engine may apply to data associated with different software, formats, tools, kits, engines, compressions, and/or the like. The data-proxy solutions disclosed herein may be deployed in a multi-cloud environment, such as the computing environment 100 of FIG. 1.

FIG. 1 depicts an exemplary cloud computing environment 100 that may be utilized with techniques presented herein. In some embodiments, cloud computing environment 100 may be, may include, and/or may form a portion of a secure cross domain solution. FIG. 1 includes data proxy 104 that may be in communication with a plurality of secure sources 102A (e.g., an information technology service management (ITSM) ticket generation system), 102B (e.g., kubernete (K8) containers), and 102C (e.g., documents based source). Secure sources 102A, 102B, and 102C may be part of a secured network or may be associated with individuals, components, or entities which transmit or receive secure data. Data proxy 104 may also be in communication with a plurality of open sources 106A (e.g., ITSM ticket resolution system), 106B (e.g., K8 containers), and 106C (e.g., documents recipient). Open sources 106A, 106B, and 106C may be public sources or may otherwise be considered non-secure sources, especially in comparison to the secure sources.

Data proxy 104 may facilitate enterprise operations and communication across security domain boundaries instead of limiting operations and/or communication to isolated networks that explicitly deny inbound traffic unless the traffic comes from a trusted source. Data proxy 104 may facilitate at least outbound communication in direction 126A sourced from a secure (e.g., classified network or restricted source) source. The outbound communication may traverse from the secure source via data proxy 104 to facilitate a trust and mutual authentication schema.

According to an implementation, data proxy 104 may be a hardware component such that network traffic to and from a secure source is routed via the hardware component. The hardware component may be connected to one or more wireless routers such that data may be received at the wireless router and provided to the hardware component. Similarly, data provided from the hardware component may be transmitted wirelessly from the hardware component via the wireless router. Alternatively, or in addition, data may be transmitted to/from the hardware component using one or more wired connections. According to another implementation, data proxy 104 may be a software or firmware component and may be implemented using one or more processors, servers, memory, or the like.

As discussed herein, access to data proxy 104 may be provided using a software. The software will be referred to as proxy software herein. The proxy software may be installed at each secure source (e.g., on each user's computer) such that each user or entity may use the software to transmit data via data proxy 104. Although a user or entity may be required to authenticate credentials to access the proxy software, the proxy software may operate in the background of a given electronic component (e.g., computer). A proxy software component at a trust manager (e.g., installed at trust manager 104A) may interact with the software component at a secure server end of data proxy 104, to transmit or receive data.

Similarly, proxy software may be installed at each open source (e.g., on each open source entity's server) such that each open source user or entity may use the software to receive data via the data proxy 104. Although a user or entity may be required to authenticate credentials to access the proxy software, the proxy software may operate in the background of a given electronic component (e.g., computer). A proxy software component at a trust manager (e.g., installed at trust manager 104C) may interact with the software component at an open server end to transmit or receive data.

Data proxy 104 may include multiple trust managers 104A and 104C as well as a guard 104B that separates each trust manager 104A and 104C. Trust managers 104A and 104C may be configured to register proxy software with one or more authorized accounts. The registration may include a verification of the registration, and/or facilitating a registration and verifying the facilitated registration. Trust managers 104A and 104C may also be configured to redact data and authenticate redacted data for transmission through guard 104B. Trust managers 104A and 104C may operate as software that is run on one or more servers (e.g., a hardware component of data proxy 104). Data proxy 104 and its components, including trust managers 104A and 104C and guard 1046, may operate as a trust unit such that each of the components of data proxy 104 may trust each other (e.g., such that data provided by trust manager 104A may not be further authenticated by guard 1046 or trust manager 104C). Guard 1046 may receive the authenticated redacted data and run a verification process to confirm a certification of the authenticated redacted data. The certification may be appended to the authenticated redacted data by trust manager 104A or 104C. The certification may indicate that the authenticated redacted data was redacted by trust manager 104A or 104C and may include an authentication level (e.g., a security level).

As an example implementation, secure sources 102A, 102B, and 102C may each have one or more user accounts registered with a proxy software. The proxy software may be installed at one or more components (e.g., laptops, desktops, computer, computing devices, wearable devices, etc.) associated with respective accounts. The installed software may be registered with data proxy 104 such that trust manager 104A verifies each respective user of secure sources 102A, 1026, and 102C (e.g., using a log-in process). Upon verifying that a user is transmitting data from a secure source (e.g., secure sources 102A, 102B, and 102C) to data proxy 104, trust manager 104A may accept the data from the secure source. A secure source may be associated with a cloud vendor and a data proxy 104 may be connected to multiple secure sources corresponding to multiple cloud vendors. Each of the secure sources may have one or more associated cloud accounts which are generally referred to herein as user accounts.

Upon accepting data from a secure source, trust manager 104A may apply a rule engine to the data. The rule engine may apply rules based on one or more of a user providing the data, a user account, a secure source, an entity, a clearance level, or the like. The rules for the rule engine may be stored at trust manager 104A or may be stored in a memory location accessible by the trust manager 104A. Alternatively, or in addition, a rule machine learning model may be associated with trust manager 104A and may output one or more rules to be applied by trust manager 104A. For example, a rule storage server may store a plurality of rule engines and trust manager 104A may identify a given rule engine from the plurality of rule engines based on a clearance level. Trust manager 104A may provide a pointer to the rule storage server to identifying the given rules to be used by the rule engine. The rule storage server may then provide the given rules to the trust manager 104A.

Trust manager 104A may apply the rules, using the rule engine, to data received at trust manager 104A. The rule engine may identify data attributes which may be one or more of characteristics, specifics, values, text, code, relationships, associations, or the like, associated with or included in data. The rule engine may apply one or more rules to the data to remove, redact, encode, or modify the data. The resulting data after the application of the one or more rules is referred to herein as “redacted data”. The redacted data may be authenticated at the trust manager 104A for transmission. In generating and authenticating the redacted data, the trust manager 104A may act as a roots of trust (RoT) module where a RoT may be a set of functions in a trusted computing module (e.g., data proxy 104) that is trusted by computing environment 100. A RoT serves as separate computing engine to control the trusted computing platform processor in computing environment 100.

The authenticated redacted data may pass through guard 1046 of data proxy 104 and may be provided to trust manager 104C. Trust manager 104C may be configured to authenticate the one or more open sources (e.g., open sources 106A, 106B, and 106C). Trust manager 104C may be connected to the one or more open sources using the proxy software installed at one or more components of the one on more open sources. The proxy software may be the same software as the software installed at the one or more secure sources, as disclosed herein. Alternatively, the software may be a different software, an instance of the same software, a version of the same software, or an open source counterpart to the secure source proxy software, as the software installed on the one or more secure sources.

Trust manager 104C may determine whether a given open source (e.g., open sources 106A, 106B, and 106C) meets a trust threshold. According to an implementation, the trust threshold may be determined by a trust machine learning model. A trust machine learning model may output one or more trust values for attributes of a given open source and may compare the trust value to the trust threshold. The trust threshold may be a static threshold or may be determined by the trust machine learning model (e.g., based on one or more of an open source attribute, the authenticated redacted data, a secure source, or the like). The trust machine learning model may be trained (e.g., supervised, unsupervised, semi-supervised, etc.) using training data that provides historical or target trust values based on training open source attributes, training data, training secure sources, or the like. One or more weights, layers, and/or biases of the trust machine learning model may be adjusted based on such training data. Alternatively, or in addition, the trust machine learning model may be trained by receiving training open source attributes, training data, training secure sources, and clustering such information to adjust one or more weights, layers, and/or biases of the rule machine learning model. Once trained, the trust machine learning model may receive, as inputs, open source attributes, authenticated redacted data, a secure source, or the like. The trust machine learning model may apply the inputs to one or more weights, layers, and/or biases of the trust machine learning model and may output a trust value for the intended communication. It may compare the trust value to a static or dynamic trust threshold to determine whether a given open source meets the trust threshold for a given communication. It will be understood that an open source may meet a trust threshold for a first communication but may not meet a trust threshold for a second communication (e.g., based on different authenticated redacted data, different secure sources, or the like). An open source that meets a meets a trust threshold may be designated an authenticated open source.

Trust manager 104C may provide the authenticated redacted data to an authenticated open source. A specific open source (e.g., open sources 106A, 106B, and 106C) may be identified based on destination location information contained in the authenticated redacted data (e.g., in one or more headers). The destination location information may be identified based on application of one or more rules from a rule engine associated with the trust manager 104C.

According to an implementation, one or more open sources (e.g., open sources 106A, 106B, and 106C) may provide data to one or more secure sources via data proxy 104. Upon accepting data from an open source based on a registration of the open source with data proxy 104, trust manager 104C may apply a rule engine to the data. The rule engine may be applied based on one or more of a data type, data content, open source, or the like. The rule engine may be stored at trust manager 104C or may be stored in a memory location accessible by trust manager 104C.

Trust manager 104C may apply the rules of a rule engine to data received at trust manager 104C from an open source. The rule engine may identify any security or other issues (e.g., malware, viruses, etc.), and may only authenticate data that are not identified as having security or other issues. The rule engine may apply one or more rules to the data to remove or modify the data and may authenticate the resulting data. The authenticated resulting data may pass through guard 1046 of data proxy 104 and may be provided to trust manager 104A. Trust manager 104A may provide the resulting data to an applicable secure source (e.g., an applicable secure source that is authenticated by trust manager 104A).

According to various implementations of the disclosed subject matter, guard 1046 may include at least two guards. Each of the two guards may be configured for unidirectional traffic flow such that a first guard of the two guards may act as a diode for traffic flow in a first direction and the second guard of the two guards may act as a diode for traffic flow in a second direction. In reference to FIG. 1, guard 1046 may include a first guard that facilitates traffic flow in direction 126A and a second guard that facilitates traffic flow in direction 126B. Accordingly, it will be understood that a guard disclosed herein that facilitates bi-directional traffic comprises two guards that act as diodes for each of the two directions, each of the two guards facilitating unidirectional traffic.

The secure sources and trust manager 104A may be isolated from the open sources and trust manager 104C by guard 104B. Guard 104B may prevent any direct communication or data transfers between the secure sources and the open sources. Such prevention may ensure that all data that is provided from the secure sources is properly redacted and authenticated before being provided to an open source. Such prevention also may ensure that unauthorized data is not provided to the secure sources to mitigate security issues.

The secure sources 102A, 102B, and 102C, data proxy 104, and open sources 106A, 1066, and 106C may communicate with each other via an electronic network 125. Although a single electronic network 125 between both the secure sources, data proxy 104, and the open sources is shown in FIG. 1, it will be understood that a secure source may communicate with a data proxy via a first electronic network and an open source may communicate with a data proxy via a different second electronic network.

In various embodiments, electronic network 125 may be one network with a secure component and an open component or may be two different networks where one network is a secure network and the other network is an open network. Communication to/from secure sources 102A, 102B, and 102C, data proxy 104 may be over the secure component or secure network and communication to/from open sources 106A, 106B, and 106C may be over the open component or open network. The electronic network 125 may include or be a wide area network (“WAN”), a local area network (“LAN”), personal area network (“PAN”), or the like. In some embodiments, electronic network 125 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). In some embodiments, electronic network 125 includes or is in communication with a telecommunications network, e.g., a cellular network.

It should be understood that data described as stored on a memory of a particular system or hardware in some embodiments, may be stored in another memory or distributed over a plurality of memories (e.g., cloud storage components) of one or more systems and/or devices in other embodiments. Additionally, or alternatively, some or all of the components of FIG. 1 may be part of the same entity that may receive data from one or more components (e.g., secure sources 102A, 102B, and 102C may each be associated with the same entity) and may transmit data to one or more components. The entity may physically house these components in the same or different locations or may access these components via a cloud-based connection or cloud server (e.g., via electronic network 125).

In the implementations described herein, various acts are described as performed or executed by components from FIG. 1. However, it should be understood that in various implementations, various components of the computing environment 100 discussed above may execute instructions or perform acts including the acts discussed herein and that any act attributed to a particular component herein need not necessarily be performed by that particular component. Further, it should be understood that in various implementations, one or more steps may be added, omitted, and/or rearranged in any suitable manner.

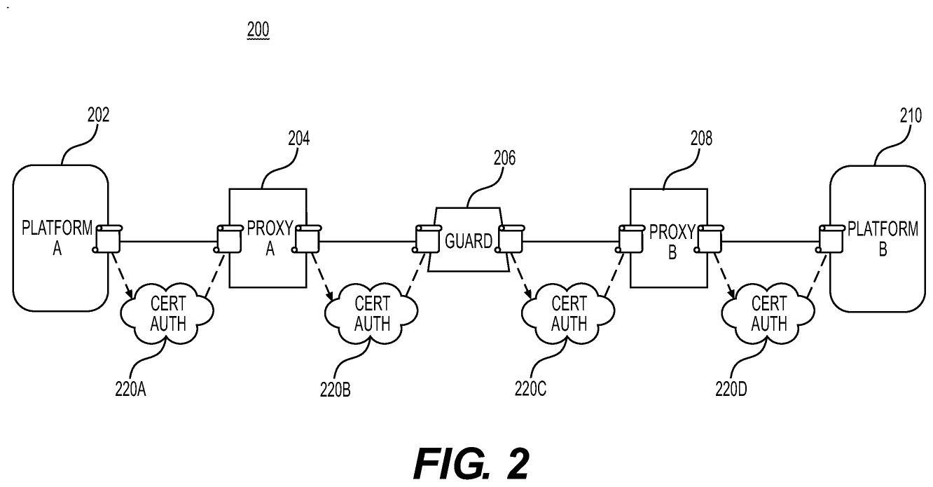

FIG. 2 shows a breakout diagram corresponding to computing environment 100 of FIG. 1. The breakout diagram includes a proxy authorization flow 200 including platform A 202, proxy A 204, guard 206, proxy B 208, and platform B 210. In the implementation shown in FIG. 2, proxy traffic may flow one way through the proxy A 204, guard 206, and proxy B 208. A rule engine may be applied at proxy A such that only redacted data is provided to the guard 206. The guard 206 may apply a data inspection protocol. Data in platform A 202 may be shared with platform B 210 through proxy A 204, guard 206, and proxy B 208. Proxy A 204, guard 206, and proxy B 208 may be components of data proxy 104 of FIG. 1.

As shown in FIG. 2, each junction 212A, 212B, 212C, and 212D may utilize a different Secure Sockets Layer (SSL) certificate (e.g., SSL certificates 220A, 220B, 220C, and 220D shown in FIG. 2) to establish trust and mutual authentication. In FIG. 2, platform A 202 may be a high-side network (i.e., more secure than a low-side network). Proxy A 204 may authenticate data from platform A and apply a rule engine to classify the data and redact any sensitive information prior to the data being provide across the guard 206. Guard 206 may be the same as or similar to guard 104B of FIG. 1. Guard 206 may operate as a data diode that is a unidirectional security gateway hardware device. The guard may confirm the authentication of the data, as provided by proxy A 204, and may provide the redacted data for the low-side network to proxy B 208. Proxy B 208 may vet the redacted data prior to passing it onto platform B 210. According to an implementation, a similar flow of data may occur between in reverse, from a low-side network to a high-side network.

The techniques provided herein allow secure transmission of data. In order to mitigate security risks, the data proxy solution provided herein facilitates data transmission one way at a time, between networks. Additionally, the proxy software itself provides an added layer of security by, for example, only accepting data from and providing data to users or entities that register with the software.

According to an implementation of the disclosed subject matter, the high-side network and secure source may correspond for a user or electronic component securing non-classified data. For example, a user may on a public or private network and may provide rules to a rule engine that is configured to comply with general data protection regulation (GDPR) procedures. With reference to FIG. 1, the user's data may be from a secure source and a user device (e.g., a mobile phone) may be operating a proxy software registered with data proxy 104. The user's data may be provided to data proxy 104 and trust manager 104A may receive the data and authenticate at the data came from the user device. Trust manager 104A may retrieve rules based on an internet coordinator associated with the user (e.g., a coordinator that maintains GDPR user designated settings) and may apply the retrieved rules to the user data. For example, the user may provide a social security number, credit card number, and credit card expiration date. The rules may dictate that the user's social security number cannot be transmitted to a low-side network. Accordingly, the trust manager 104A may redact the user's social security number and provide the redacted data to the guard 104B. The guard 104B may pass the redacted data onto the trust manager 104C that may provide the redacted data to an open source based on, for example, information included in the redacted data.

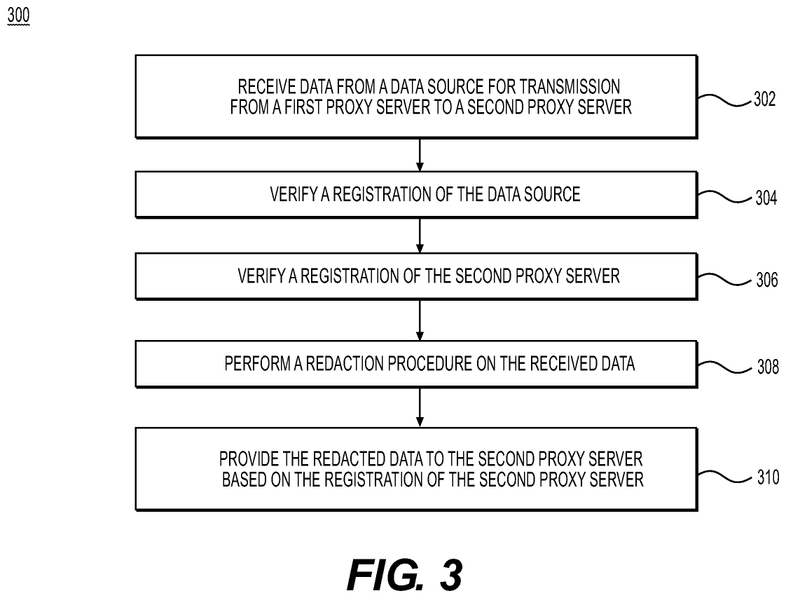

FIG. 3 shows a process 300 for providing redacted data to a proxy server, in accordance with an implementation of the disclosed subject matter. At 302, data may be received from a data source for transmission from a first proxy server to a second proxy server. The first proxy server may be part of a high-side network and the second proxy server may be part of a low-side network. The data may be received at a data proxy (e.g., data proxy 104 of FIG. 1) via a network connection (e.g., via electronic network 125).

At 304, registration of the data source may be verified. The registration may be verified via a proxy software used by the data source that is also associated with the data proxy. The registration may be based on identification information of a data source. The verification may include confirming the registration status as well as credentials associated with the data source that provided the data at 302. As disclosed in reference to FIG. 1, a first trust manager (e.g., trust manager 104A) may verify the data source. Upon verification, the data source may be authenticated. According to an implementation, verification of the data source may also include or may be verification of the first proxy server.

At 306, registration of a second proxy server may be verified. The registration of the second proxy server may be verified via a proxy software used by the second proxy server that is also associated with the data proxy. The verification may include confirming the registration status as well as credentials associated with second proxy server that is to receive a version of the data received at 302. As disclosed in reference to FIG. 1, a second trust manager (e.g., trust manager 104C) may verify the second proxy server such that the second trust manager is different than the first trust manager that verified the data source at 304. Verification may be based on a trust threshold, as disclosed herein.

At 308, a redaction procedure may be performed on the received data. The redaction procedure may be performed using a rule engine that applies rules based on the received data, data source, and/or one or more other factors as discussed herein. The redacted data may be a redaction, modification, or removal of data. The redacted data may be provided to a guard that may verify the redacted data and provide it to a second trust manager (e.g., trust manager 104C of FIG. 1).

At 310, the redacted data generated at 308 may be provided by the second trust manager to the second proxy server. Accordingly, the second proxy server may receive data that does not include secure information, as a result of the redaction.

As discussed herein, one or more components of the disclosed subject matter may be implemented using one or more machine learning models. The rule engine that is applied by a given trust manager may select rules that are determined by a rule machine learning model and/or may use rule thresholds determined by a rule machine learning model. For example, a machine learning model may be trained to determine optimal rule thresholds for including data in a redaction set. The rule thresholds may be determined by the machine learning model to minimize exposure of secure information and may change based on inputs such as current events, user information, data information or the like. Accordingly, the rule machine learning model may provide rule thresholds to be used for any given data and the thresholds may change based on any changes to the input of the machine learning model.

A redaction machine learning model may also be used to determine the data to be redacted. The data to be redacted may include one or more of characteristics, specifics, values, text, code, relationships, associations, or the like. Accordingly, it may be difficult to pre-determine what data is to be redacted. A redaction machine learning model may be used to identify aspects of data to be redacted based on past redactions (e.g., in a supervised machine learning model), correlations between data and security protocols, current events, or the like. A redaction machine learning model may output one or more redactions (e.g., content, data, or information to be redacted based on a secure source, an open source, data, or the like). The output may be redacted using a redaction software module configured to redact (e.g., permanently remove data and any associated metadata) from a given communication. The redaction machine learning model may be trained (e.g., supervised, unsupervised, semi-supervised, etc.) using training data that provides historical or target trust redactions based on training open source attributes, training data, training secure sources, or the like. One or more weights, layers, and/or biases of the redaction machine learning model may be adjusted based on such training data. Alternatively, or in addition, the redaction machine learning model may be trained by receiving training open source attributes, training data, training secure sources, and clustering such information to adjust one or more weights, layers, and/or biases of the rule machine learning model. Once trained, the redaction machine learning model may receive, as inputs, open source attributes, data for transmission, secure source attributes, or the like. The redaction machine learning model may apply the inputs to one or more weights, layers, and/or biases of the redaction machine learning model and may output redactions to the data for transmission. It will be understood that data for a given transmission may be redacted different based on one or more inputs (e.g., secure source, open source, etc.), when compared to a different transmission based on different inputs.

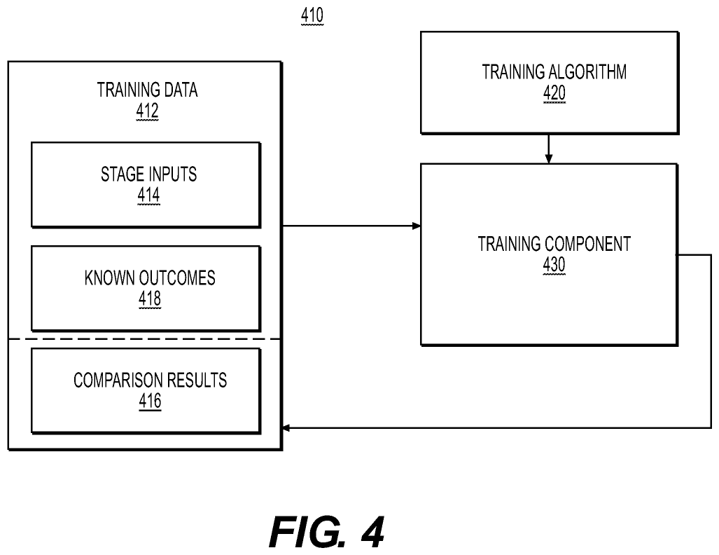

FIG. 4 shows an example training module 410 to train one or more of the machine learning models that may be used to implement techniques disclosed herein. It will be understood that a different training module may be used to train each of the machine learning models disclosed herein and/or single training module 410 may be used to train two or more machine learning models.

As shown in FIG. 4, training data 412 may include one or more of stage inputs 414 and known outcomes 418 related to a machine learning model to be trained. Stage inputs 414 may be from any applicable source including capabilities of management module 105, an output from a stage (e.g., one or more outputs from a stage from process 300 of FIG. 3), or the like. Known outcomes 418 may be included if the machine learning model is generated based on supervised or semi-supervised training. An unsupervised machine learning model may not be trained using known outcomes 418. Known outcomes 418 may include known or desired outputs for future inputs similar to or in the same category as stage inputs 414 that do not have corresponding known outputs.

Training data 412 and training algorithm 420 may be provided to training component 430 that may apply training data 412 to training algorithm 420 to generate a machine learning model. According to an implementation, training component 430 may be provided comparison results 416 that compare a previous output of the corresponding machine learning model to apply the previous result to re-train the machine learning model. Comparison results 416 may be used by training component 430 to update the corresponding machine learning model. Training algorithm 420 may utilize machine learning networks and/or models including, but not limited to a deep learning network.

It should be understood that embodiments in this disclosure are exemplary only, and that other embodiments may include various combinations of features from other embodiments, as well as additional or fewer features.

In general, any process or operation discussed in this disclosure that is understood to be computer-implementable, such as the processes illustrated in FIGS. 3 and 4, may be performed by one or more processors of a computer system, such any of the systems or components in computing environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or components in FIG. 1. One or more processors of a computer system may be included in a single computing device or distributed among a plurality of computing devices. One or more processors of a computer system may be connected to a data storage device. A memory of the computer system may include the respective memory of each computing device of the plurality of computing devices.

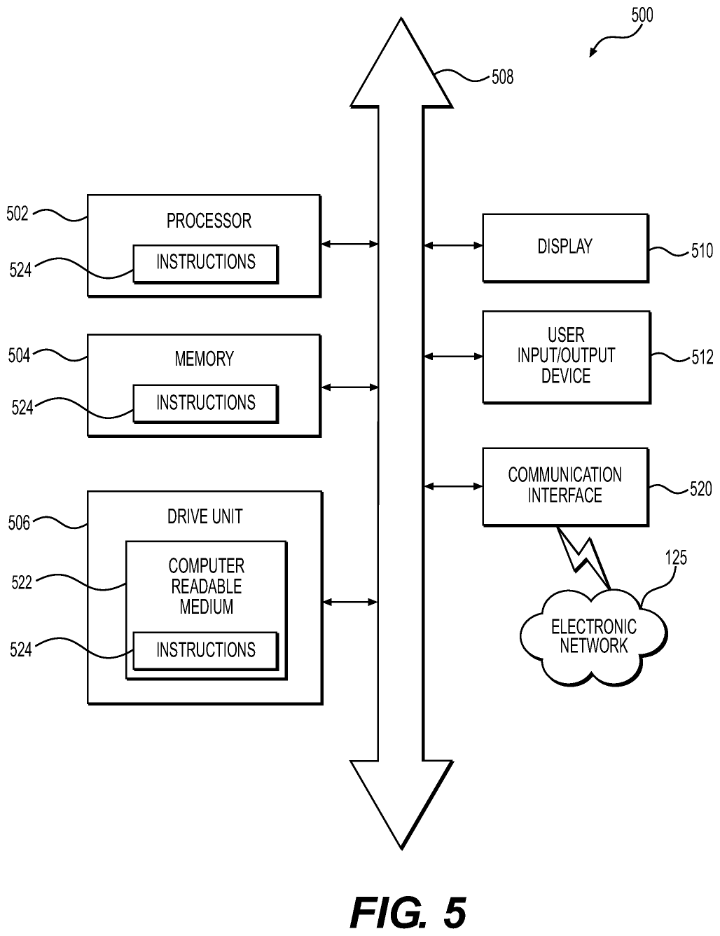

FIG. 5 is a simplified functional block diagram of computer system 500 that may be configured as a device for executing the methods of FIGS. 3 and/or 4, according to exemplary embodiments of the present disclosure. FIG. 5 is a simplified functional block diagram of a computer system that may generate interfaces and/or another system according to exemplary embodiments of the present disclosure. In various embodiments, any of the systems (e.g., computer system 500) herein may be an assembly of hardware including, for example, data communication interface 520 for packet data communication. Computer system 500 also may include central processing unit (“CPU”) 502, in the form of one or more processors, for executing program instructions. The computer system 500 may include an internal communication bus 508, and storage drive unit 506 (such as ROM, HDD, SDD, etc.) that may store data on computer readable medium 522, although the computer system 500 may receive programming and data via network communications. Computer system 500 may also have memory 504 (such as RAM) storing instructions 524 for executing techniques presented herein, although the instructions 524 may be stored temporarily or permanently within other modules of computer system 500 (e.g., processor 502 and/or computer readable medium 522). Computer system 500 also may include input and output ports 512 and/or display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Aspects of the technology disclosed herein may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, a mobile device, a wearable device, an application, or the like (e.g., that is used to operate management module 105). Also, the presently disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for providing a cross domain solution for communication of secure data using a plurality of machine learning models, the method comprising:
receiving, at a first trust manager of a data proxy, first data from a first proxy server, wherein the first data comprises a destination location for a second proxy server;
verifying, by the first trust manager, a registration of the first proxy server, wherein the verifying comprises confirming a credential;
receiving second server attributes of the second proxy server and providing the second proxy server attributes as inputs to a trust machine learning model;
verifying the second proxy server based on a trust value output by the trust machine learning model;
receiving the first data based on verifying the first proxy server, identification information of the first proxy server, and identification information of the second proxy server as an input to a rule machine learning model;
receiving a rule engine as an output of the rule machine learning model;
applying the rule engine to the first data;
performing a redaction procedure for the first data based on applying the rule engine to the first data, to output redacted data; and
providing the redacted data to the second proxy server based on the destination location and the verifying the second proxy server.

2. The method of claim 1, wherein performing the redaction procedure comprises:
receiving the first rule engine and the first data at a redaction machine learning model;
receiving one or more redactions as an output from the redaction machine learning model; and
applying the one or more redactions using a redaction software module, to generate the redacted data.

3. The method of claim 1, wherein the first proxy server is a secure source.

4. The method of claim 1, wherein the second proxy server is an open source.

5. The method of claim 1, wherein providing the redacted data to the second proxy server comprises:
receiving the redacted data at a guard;
verifying, by the guard, a certification of the redacted data, the certification applied by the first trust manager; and
providing the redacted data to a second trust manager, based on verifying the certification, wherein the second trust manager is configured to provide the redacted data to the second proxy server.

6. The method of claim 5, wherein the guard comprises a first guard and a second guard, wherein the first guard is configured to verify certifications from the first trust manager and the second guard is configured to verify certifications from the second trust manager.

7. The method of claim 1, further comprising:
receiving, at a second trust manager of the data proxy, second data from the second proxy server, wherein the second data comprises a secure destination location for the first proxy server;
receiving the second data, the identification information of the first proxy server, and identification information of the second proxy server as an input to the rule machine learning model;
receiving, as an output of the rule machine learning model, a second rule engine;
applying the second rule engine to the second data; and
performing a second redaction procedure for the second data based on second the rule engine to output a second redacted data; and
providing the second redacted data to the first proxy server based on the secure destination location.

8. The method of claim 6, wherein the second redaction procedure removes at least one of a virus or a malware from the second data.

9. A method for providing a cross domain solution for communication of secure data, the method comprising:
receiving, at a first trust manager of a data proxy, first data from a first proxy server, wherein the first data comprises a destination location for a second server;
verifying, by the first trust manager, a registration of the first proxy server, wherein the verifying comprises confirming a first credential;
verifying, by a second trust manager of the data proxy, a registration of the second proxy server, wherein the verifying comprises confirming a second credential;
performing a redaction procedure for the first data based on verifying the first proxy server and the second proxy server, to output redacted data based on the first data; and
providing the redacted data to the second proxy server based on the registration of the second proxy server and the destination location.

10. The method of claim 9, further comprising:
receiving the first data, identification information of the first proxy server, and identification information of the second proxy server as an input to a rule machine learning model;
receiving, as an output of the rule machine learning model, a rule engine based on the first data, the identification information of the first proxy server, and the identification information of the second proxy;
applying the rule engine to the first data; and
performing the redaction procedure for the first data based on the rule engine.

11. The method of claim 10, wherein performing the redaction procedure comprises:
receiving the rule engine and the first data at a redaction machine learning model;
receiving one or more redactions as an output from the redaction machine learning model; and
applying the one or more redactions using a redaction software module, to generate the redacted data.

12. The method of claim 9, further comprising:
receiving second server attributes of the second proxy server and providing the second proxy server attributes as inputs to a trust machine learning model; and
verifying the registration of the second proxy server further based on a trust value output by the trust machine learning model.

13. The method of claim 9, wherein the first proxy server is a secure source.

14. The method of claim 9, wherein the second proxy server is an open source.

15. The method of claim 9, wherein providing the redacted data to the second proxy server comprises:
receiving the redacted data at a guard;
verifying, by the guard, a certification of the redacted data, the certification applied by the first trust manager; and
providing the redacted data to a second trust manager, based on verifying the certification, wherein the second trust manager is configured to provide the redacted data to the second proxy server.

16. The method of claim 15, wherein the guard comprises a first guard and a second guard, wherein the first guard is configured to verify certifications from the first trust manager and the second guard is configured to verify certifications from the second trust manager.

17. The method of claim 9, further comprising:
receiving, at the second trust manager, second data from the second proxy server, wherein the second data comprises a secure destination location for the first proxy server;
receiving the second data, identification information of the first proxy server, and identification information of the second proxy server as an input to a rule machine learning model;
receiving, as an output of the rule machine learning model, a second rule engine;
applying the second rule engine to the second data; and
performing a second redaction procedure for the second data based on second the rule engine to output a second redacted data; and
providing the second redacted data to the first proxy server based on the secure destination location.

18. A system for providing a cross domain solution for communication of secure data, the system comprising:
at least one memory storing instructions; and
at least one processor executing the instructions to perform a process, the processor configured to:
receive, at a first trust manager of a data proxy, first data from a first proxy server, wherein the first data comprises a destination location for a second server;
verify, by the first trust manager, a registration of the first proxy server, wherein the verifying the registration of the first proxy server comprises confirming a first credential;
verify, by a second trust manager of the data proxy, a registration of the second proxy server, wherein the verifying the registration of the second proxy server comprises confirming a second credential;
perform a redaction procedure for the first data based on verifying the first proxy server and the second proxy server, to output redacted data based on the first data; and
provide the redacted data to the second proxy server based on the registration of the second proxy server and the destination location.

19. The system of claim 18, wherein the processor is further configured to;
receive the first data, identification information of the first proxy server, and identification information of the second proxy server as an input to a rule machine learning model;
receive, as an output of the rule machine learning model, a rule engine based on the first data, the identification information of the first proxy server, and the identification information of the second proxy;
apply the rule engine to the first data; and
perform the redaction procedure for the first data based on the rule engine.

20. The system of claim 19, wherein the processor is further configured to:
receive second server attributes of the second proxy server and providing the second proxy server attributes as inputs to a trust machine learning model; and
verify the registration of the second proxy server further based on a trust value output by the trust machine learning model.
